(19) United States
(12) Patent Application Publication
(10) Pub. No.: US 2020/0361203 A1
(43) Pub. Date: Nov. 19, 2020

(54) INFORMATION PROCESSING APPARATUS, PRINTING APPARATUS, LEARNING APPARATUS, AND INFORMATION PROCESSING METHOD

(71) Applicant: SEIKO EPSON CORPORATION, Tokyo (JP)

(72) Inventors: Haruhisa KURANE, Shiojiri-shi (JP); Tetsuo TATSUDA, Ina-shi (JP); Yuichi SHIKAGAWA, Azumino-shi (JP); Mamoru UKITA, Shiojiri-shi (JP); Shigenori KATAYAMA, Okaya-shi (JP); Kazunari TSUKADA, Matsumoto-shi (JP)

(21) Appl. No.: 15/931,274

(22) Filed: May 13, 2020

(30) Foreign Application Priority Data
May 16, 2019 (JP) 2019-092606

(51) Int. Cl. B41J 2/045

(52) U.S. Cl. CPC B41J 2/0451; B41J 2/04581

(57) ABSTRACT

An information processing apparatus includes a storage that stores a machine-learned model, an accepting section, and a processor. In the machine-learned model, according to a data set in which an association is made between discharge failure factor information related to the factor of a discharge failure and printed image information that represents an image formed on a print medium, a prediction condition has been machine-learned for the discharge failure. The accepting section accepts the discharge failure factor information from a printing apparatus. The processor predicts the discharge failure in the print head according to the accepted discharge failure factor information and the machine-learned model.

The present application is based on, and claims priority from JP Application Serial Number 2019-092606, filed May 16, 2019, the disclosure of which is hereby incorporated by reference herein in its entirety.

### BACKGROUND

### 1. Technical Field

The present disclosure relates to an information processing apparatus, a printing apparatus, a learning apparatus, an information processing method, and the like.

### 2. Related Art

A method, known in related art, of detecting a discharge failure in a nozzle in an ink jet printer is used. A discharge failure refers to the inability to discharge droplets due to clogging in a nozzle. JP-A-2013-111768, for example, discloses a method of detecting a discharge failure in a nozzle by using two detectors. In JP-A-2013-111768, a first detector uses a line camera to directly monitor printed matter. A second detector monitors a driving signal for a piezoelectric element used to cause ink to be discharged from a nozzle.

In processing in the method in JP-A-2013-111768, when a discharge failure is detected by the first detector, the second detector makes a decision. According to two decision results, a nozzle having the discharge failure is identified. After a discharge failure has been actually detected, recovery processing such as cleaning is performed. This causes waste paper, which is unusable printed matter. Here, waste paper particularly represents printed matter that does not reach the level of demanded printing quality due to improper ink discharging.

### SUMMARY

One aspect of the present disclosure relates to an information processing apparatus that includes: a storage that stores a machine-learned model in which, according to a data set in which an association is made between discharge failure factor information related to the factor of a discharge failure in a print head that discharges ink and printed image information that represents an image formed on a print medium by the ink discharged from the print head, a prediction condition has been machine-learned for the discharge failure in the print head; an accepting section that accepts the discharge failure factor information from a printing apparatus having the print head; and a processor that predicts the discharge failure in the print head according to the machine-learned model and the accepted discharge failure factor information that was accepted.

### BRIEF DESCRIPTION OF THE DRAWINGS

FIG. 1 illustrates an example of the structure of a printing apparatus.

FIG. 2 illustrates a structure around print heads.

FIG. 3 illustrates an arrangement of a plurality of print heads.

FIG. 4 also illustrates the structure around print heads.

FIG. 5 illustrates an example of the structure of an imaging section.

FIG. 6 is a cross-sectional view of the print head.

FIG. 7 is a drawing to explain a method of deciding a discharge failure according to waveform information about residual vibration.

FIG. 8 schematically illustrates the entry of a bubble.

FIG. 9 schematically illustrates an increase in the viscosity of ink.

FIG. 10 schematically illustrates the adhesion of foreign matter.

FIG. 11 illustrates waveform information about residual vibration matching a nozzle state.

FIG. 12 illustrates an example of the structure of a learning apparatus.

FIG. 13 illustrates a neural network.

FIG. 14 illustrates an example of training data.

FIG. 15 illustrates an example of inputs to and outputs from a neural network.

FIG. 16 illustrates another example of training data.

FIG. 17 illustrates another example of inputs to and an output from a neural network.

FIG. 18 illustrates yet another example of inputs to and outputs from a neural network.

FIG. 19 illustrates an example of the structure of an information processing apparatus.

FIG. 20 illustrates another example of the structure of the information processing apparatus.

FIG. 21 is a flowchart illustrating processing in the information processing apparatus.

FIG. 22 illustrates the structure of a neural network in inference processing.

FIG. 23 is a flowchart for processing in additional learning.

### DESCRIPTION OF EXEMPLARY EMBODIMENTS

An embodiment of the present disclosure will be described below. This embodiment described below does not unreasonably restrict the contents described in the scope of claims. All of the structures described in this embodiment are not always essential structural requirements.

### 1. Overview

### 1.1 Example of the Structure of a Printing Apparatus

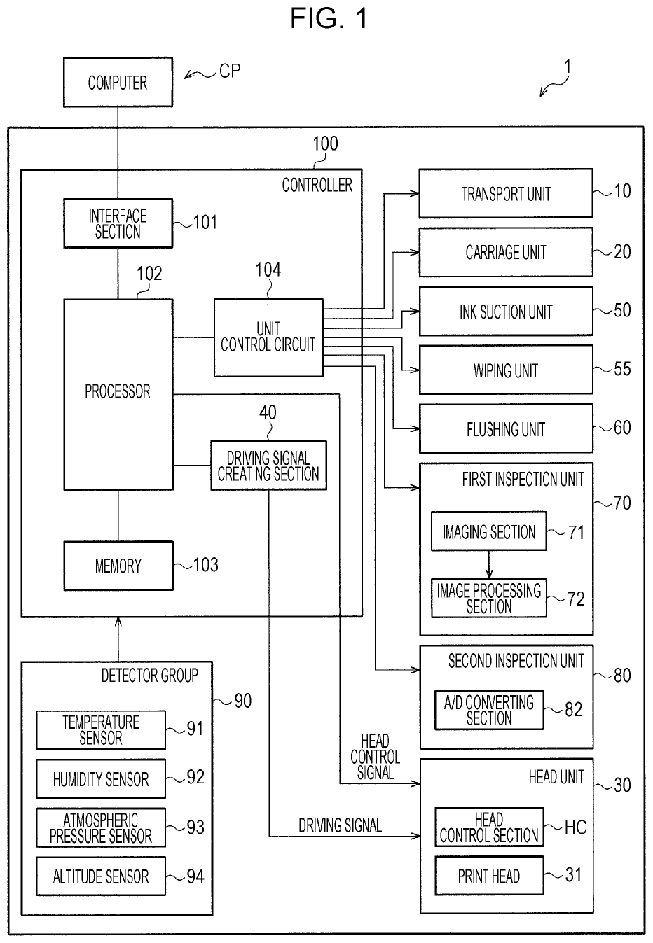

FIG. 1 illustrates an example of the structure of a printing apparatus 1 according to this embodiment. As illustrated in FIG. 1, the printing apparatus 1 includes a transport unit 10, a carriage unit 20, a head unit 30, a driving signal creating section 40, an ink suction unit 50, a wiping unit 55, a flushing unit 60, a first inspection unit 70, a second inspection unit 80, a detector group 90, and a controller 100. The printing apparatus 1 discharges ink toward a print medium such as paper, a cloth, or a film. The printing apparatus 1 is coupled to the computer CP so as to be capable of communicating with the computer CP. To have the printing apparatus 1 print an image, the computer CP transmits print data matching the image to the printing apparatus 1. The print data includes to-be-printed image data representing the image as well as print setting information according to which the size of the print medium, printing quality, colors, and the like are determined.

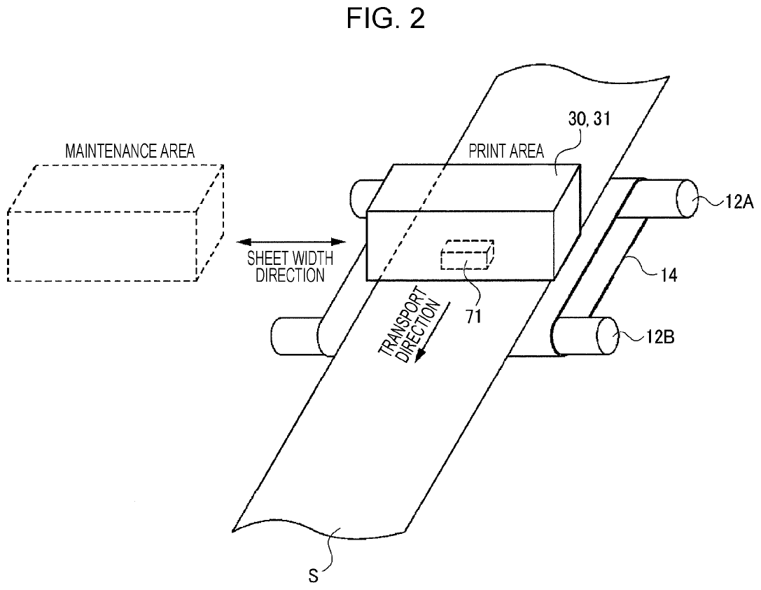

The transport unit 10 transports a print medium in a predetermined direction. The print medium is, for example, a sheet S. The sheet S may be a print sheet with a predetermined size or may be continuous paper. In the description below, the direction in which a print medium is transported will be referred to as the transport direction. The transport unit 10 has an upstream roller 12A, a downstream roller 12B, and a belt 14, as illustrated in FIG. 2. When a transport motor (not illustrated) rotates, the upstream roller 12A and downstream roller 12B rotate and the belt 14 thereby rotates. A supplied print medium is transported to a print area, in which print processing can be executed, by the belt 14. The print area opposes the head unit 30. When the belt 14 transports the sheet S, it moves in the transport direction with respect to a print head 31.

The carriage unit 20 moves the head unit 30 including the print head 31. The carriage unit 20 has a carriage supported so as to be bidirectionally movable along a guide rail in the width direction of the sheet S as well as a carriage motor. The carriage moves together with the print head 31 by being driven by the carriage motor. When the carriage moves in the sheet width direction, the print head 31, which has been positioned in the print area, moves to a maintenance area different from the print area. In the maintenance area, recovery processing can be executed.

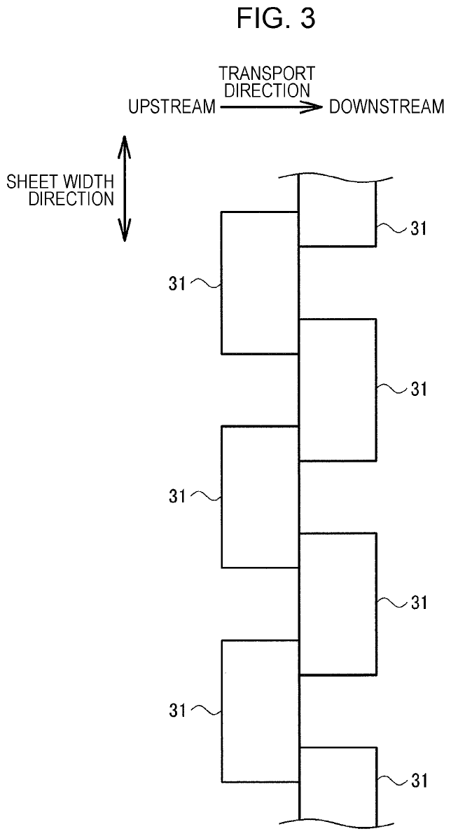

The head unit 30 discharges ink toward the sheet S that has been transported to the print area by the transport unit 10. When ink is discharged toward the sheet S by the head unit 30 while the sheet S is being transported, dots are formed on the sheet S, printing an image on the sheet S. Since the printing apparatus 1 in this embodiment is, for example, a printer in a line head method, the head unit 30 can form dots for the sheet width at one time. The head unit 30 has a plurality of print heads 31 placed in a staggered arrangement along the sheet width direction as illustrated in FIG. 3. The head unit 30 also has a head control section HC that controls the print heads 31 in response to a head control signal from the controller 100.

Each print head 31 has, for example, a black ink nozzle row, a cyan ink nozzle row, a magenta ink nozzle row, and a yellow ink nozzle row on the bottom surface of the print head 31. Different nozzle rows discharge inks in different colors toward the sheet S. The print head 31 in this embodiment may have nozzle rows only in a particular ink color. In practice, nozzles are at different positions in the transport direction as illustrated in FIG. 3. When timings at which to discharge ink are varied, however, nozzles constituting nozzle rows in each print head 31 can be thought to be arranged in a row.

When ink droplets are non-continuously discharged from each nozzle to a sheet S while it is being transported, nozzles form raster lines on the sheet S. For example, a first nozzle forms a first raster line on the sheet S, and a second nozzle forms a second raster line on the sheet S. In the description below, the direction of the raster line will be referred to as the raster direction.

When a discharge failure occurs in a nozzle, an appropriate dot is not formed on the sheet S. A discharge failure represents a state in which an ink droplet is not appropriately discharged due to clogging in a nozzle. In the description below, a dot that has not been appropriately formed will be referred to as a failed dot. Once a discharge failure occurs in a nozzle, it hardly recovers autonomously from the discharge failure, so discharge failures occur in succession. Then, failed dots occur in succession on the sheet S in the raster direction. On the printed image, therefore, failed dots are observed as a white or bright stripe.

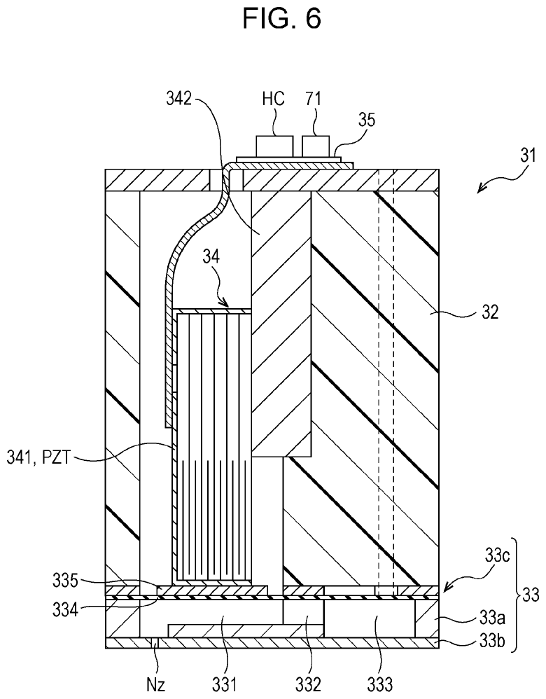

The driving signal creating section 40 creates a driving signal. When a driving signal is applied to a piezoelectric element PZT, which is a driving element, the piezoelectric element PZT expands and contracts, changing the volume of a pressure chamber 331 corresponding to the relevant nozzle Nz. A driving signal is applied to the print head 31 during print processing, processing to detect a discharge failure by using the second inspection unit 80, flushing processing, or the like. A specific example of the print head 31 including piezoelectric elements PZT will be described later with reference to FIG. 6.

The ink suction unit 50 sucks ink in the print head 31 from the nozzles Nz in it and expels the ink to the outside of the print head 31. In a state in which a cap (not illustrated) is placed in tight contact with the nozzle surface of the print head 31, the ink suction unit 50 operates a suction pump (not illustrated) to generate negative pressure in space inside the cap and suck ink in the print head 31 together with a bubble that has entered the interior of the print head 31. Thus, the nozzle Nz can recover from the discharge failure.

The wiping unit 55 removes foreign matter, such as paper dust, adhering to the nozzle surface of the print head 31. The wiping unit 55 has a wiper that can abut the nozzle surface of the print head 31. The wiper is formed from an elastic member having flexibility. When the carriage is driven by the carriage motor and moves in the sheet width direction, the end of the wiper abuts the nozzle surface of the print head 31, warps, and cleans the nozzle surface. Thus, the wiping unit 55 removes foreign matter, such as paper dust, adhering to the nozzle surface, making it possible to normally discharge ink from the nozzle Nz that has been clogged with the foreign matter.

The flushing unit 60 accepts ink discharged due to a flushing operation by the print head 31, and holds the ink. In the flushing operation, a driving signal not related to an image to be printed is applied to a driving element to forcibly discharge ink droplets from the nozzle Nz in succession. This can restrain ink from becoming more viscous or drying and thereby failing to be discharged by an appropriate amount, so the nozzle Nz can recover from the discharge failure.

The first inspection unit 70 checks for a discharge failure according to the state of the printed image formed on the sheet S. The first inspection unit 70 includes an imaging section 71 and an image processor 72. In FIG. 1, the image processor 72 and controller 100 are separately provided. However, the image processor 72 may be implemented by the controller 100. The imaging section 71 and processing in the image processor 72 will be described later in detail.

The second inspection unit 80 checks for a discharge failure for each nozzle Nz according to the state of ink in the print head 31. The second inspection unit 80 includes an analog-to-digital (A/D) converting section 82. The A/D converting section 82 performs A/D conversion on a detection signal in the piezoelectric element PZT and outputs a digital signal. The detection signal referred to here is waveform information about residual vibration. In this embodiment, a digital signal resulting from A/D conversion will be also described as waveform information about residual vibration. Waveform information about residual vibration and a method of detecting a discharge failure according to the waveform information about residual vibration will be described later with reference to FIGS. 6 to 11.

The controller 100 is a control unit that controls the printing apparatus 1. The controller 100 includes an interface section 101, a processor 102, a memory 103, and a unit control circuit 104. The interface section 101 transmits data and receives data between the printing apparatus 1 and the computer CP, which is an external apparatus. The processor 102 is an arithmetic processing apparatus that controls the whole of the printing apparatus 1. The processor 102 is, for example, a central processing unit (CPU). In the memory 103, an area to store programs for the processor 102, a working area, and the like are allocated. According to the programs stored in the memory 103, the processor 102 causes the unit control circuit 104 to control units.

The detector group 90 monitors a situation in the printing apparatus 1. The detector group 90 includes, for example, a temperature sensor 91, a humidity sensor 92, an atmospheric pressure sensor 93, and an altitude sensor 94. The altitude sensor 94 is implemented by, for example, a combination of a temperature sensor and an atmospheric pressure. A sensor that implements the altitude sensor 94 may be, for example, the temperature sensor 91 and atmospheric pressure sensor 93 or may be a different sensor. The detector group 90 may include members (not illustrated) such as a rotary encoder used in control of the transport of a print medium or the like, a paper detection sensor that detects whether a print medium to be transported is present, and a linear encoder that detects the position of the carriage in its movement direction.

So far, the printing apparatus 1 in a line head method in which print heads 31 are provided so as to cover the sheet width has been described. However, the printing apparatus 1 in this embodiment is not limited to a line head method, but may be a printing apparatus in a serial head method. In the serial head method, the print head 31 is bidirectionally moved in the main scanning direction to perform printing across the paper width.

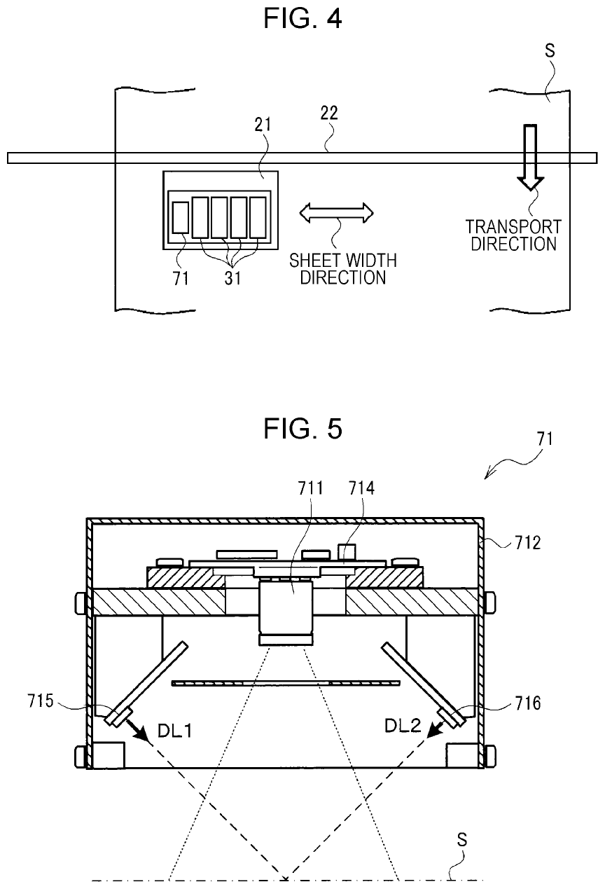

FIG. 4 is a plan view schematically illustrating the structure of the periphery of print heads 31 in the printing apparatus 1 in a serial head method. Each print head 31, which has a plurality of nozzles Nz, ejects ink from the nozzles Nz toward the print medium in response to a command from the processor 102, forming an image on the print medium. As illustrated in FIG. 4, a plurality of print heads 31 are mounted on a carriage 21. When inks in four colors are used as an example, one print head 31 is provided for ink in each color.

The print heads 31 and imaging section 71 are mounted on the carriage 21. The carriage 21 moves the print heads 31 and imaging section 71 in the sheet width direction. The sheet width direction may also be referred to as the main scanning direction. The carriage 21 is moved along a carriage rail 22 by a driving source (not illustrated) and a transmission apparatus (not illustrated). The carriage 21 is driven in response to a carriage control signal that the carriage 21 has received from the processor 102.

During printing, ink is discharged from the print heads 31 moved by the carriage 21 in the sheet width direction toward the sheet S transported in the transport direction, as illustrated in FIG. 4. As a result, an image is formed on the sheet S. The print medium is transported by the transport unit 10 as in the line head method.

### 1.2 First Inspection Unit

FIG. 5 illustrates an example of the structure of the imaging section 71 included in the first inspection unit 70. Specifically, FIG. 5 is a longitudinal cross-sectional view illustrating the structure of the interior of the imaging section 71. In the imaging section 71, an imaging unit 711, a control board 714, a first light source 715, and a second light source 716 are mounted in a case 712 in a box-like shape, the case 712 having an opening at the bottom. However, the structure of the imaging section 71 is not limited to the structure in FIG. 5.

The first light source 715 and second light source 716 are N light sources, N being equal to or larger than 2, that emit light for use for photography to a subject eligible for imaging. The first light source 715 and second light source 716 are positioned so that light emitted in their light emitting front directions DL1 and DL2 is regularly reflected at the subject. The first light source 715 and second light source 716 are each, for example, a white light emitting diode. A voltage and current supplied for driving are controlled by the control board 714 to control the amount of light.

The imaging unit 711 includes a lens and an imaging element. The imaging unit 711 is disposed so that its optical axis is directed toward a reflection position at which light from the first light source 715 and light from the second light source 716 are regularly reflected and that the imaging unit 711 is at a predetermined distance from the print medium, which is a subject.

As described above with reference to FIGS. 2 and 4, the imaging section 71 is disposed in the vicinity of the print heads 31. The printing apparatus 1 in a line head method does not need to move the head unit 30 in the sheet width direction during printing, so high-speed printing is possible. However, it is assumed that the imaging section 71 is not moved during printing. To perform imaging across the sheet width, therefore, the imaging section 71 desirably has a wide angle of view or a plurality of imaging sections 71 are desirably disposed. When the printing apparatus 1 is in the serial head method, the imaging section 71 is also moved during printing along with the driving of the carriage 21. This is advantageous in that when imaging is performed a plurality of times while the carriage 21 is being bidirectionally driven, imaging across the sheet width is easily performed. In this embodiment, either a line head method or a serial head method may be used. In the description below, it will be assumed that printed matter is appropriately imaged by the imaging section 71.

When, for example, the printing apparatus 1 is in a line head method, a nozzle group composed of nozzle rows of a plurality of print heads 31 can be thought as nozzles Nz arranged in a row, as described above. In preliminary design, therefore, a relationship is known between the position of a given nozzle Nz in the nozzle group and a position at which ink discharged from the given nozzle Nz is landed on the print medium. This relationship between the position of the nozzle Nz and the landing position is also known in the printing apparatus 1 in a serial head method as well. Captured image data resulting from the imaging of a print result by the imaging section 71 is predicted to become an image created by enlarging or reducing to-be-printed image data used in the printing at a predetermined magnification ratio. The predetermined magnification ratio referred to here is information that can be calculated from design parameters such as a nozzle interval, a transport pitch for the print medium, the resolution of the imaging element, and the lens structure of the imaging section 71.

The image processor 72 creates reference data with the same resolution as captured image data by performing scaling processing on to-be-printed image data at the predetermined magnification ratio. The image processor 72 compares the captured image data with the reference data to detect a discharge failure in the nozzle Nz.

Specifically, the controller 100 in the printing apparatus 1 starts print processing for the sheet S according to the to-be-printed image data received from the computer CP. The imaging section 71 takes a picture of the image printed on the sheet S concurrently with the print processing.

The image processor 72 acquires to-be-printed image data from the computer CP and edits the to-be-printed image data to create reference data. The image processor 72 calculates a difference in pixel value for each pixel between the captured image data and the reference data, and decides whether there is a failed dot position for each color according to the calculated difference in pixel value. The failed dot position represents a position at which a dot is not appropriately formed on the print medium due to the inability to discharge ink from the nozzle Nz. Specifically, the image processor 72 decides that there is no failed dot position when the difference in pixel value is equal to or smaller than a predetermined value and that there is a failed dot position when the difference in pixel value exceeds the predetermined value. Therefore, by making a decision about a failed dot according to the captured image, it can be decided whether there is a failed dot for each of a plurality of nozzles Nz.

However, inspection performed for a discharge failure according to captured image data is not always possible. When, for example, a given pixel in to-be-printed image data is set to the same color as the print medium, the relevant nozzle Nz does not need to discharge ink at the position of the pixel. For example, the print medium may be a normal print sheet. Then, during printing in a white area, control is performed so that the color of the print medium is maintained without discharging ink.

In this case, ink is not organically discharged for the above given pixel, so it cannot be decided whether the given pixel is at a failed dot position. For example, to-be-printed image data may be used by which a given nozzle Nz does not discharge ink even once. Then, even when a print result for the to-be-printed image data is imaged, it cannot be decided whether there is a discharge failure for the given nozzle Nz. In consideration of precision in decision, it is desirable to make a decision on the given nozzle Nz according to the result for a plurality of discharges, that is, a plurality of dots in the print result.

As described above, in a decision made by using the imaging section 71 as to whether there is a discharge failure, it is desirable to use to-be-printed image data including a pattern according to which each nozzle Nz eligible for the decision discharges ink droplets at least a predetermined number of times. In this embodiment, this pattern will be referred to as a detection-enabled pattern. That is, in inspection by the first inspection unit 70 for a discharge failure, an execution condition is to include a detection-enabled pattern in to-be-printed image data.

### 1.3 Second Inspection Unit

FIG. 6 is a cross-sectional view of the print head 31. The print head 31 includes a case 32, a flow path unit 33, and a piezoelectric element unit 34. The case 32 is a member in which piezoelectric elements PZT and the like are accommodated and are fixed. The case 32 is manufactured from, for example, a non-conductive resin material such as an epoxy resin.

The flow path unit 33 has a flow path forming substrate 33a, a nozzle palate 33b, and a vibration plate 33c. The nozzle palate 33b is joined to one surface of the flow path forming substrate 33a, and the vibration plate 33c is joined to the other surface. In the flow path forming substrate 33a, a pressure chamber 331, an ink supply path 332, and a common ink chamber 333 are formed, which are used as hollows and a groove. The flow path forming substrate 33a is manufactured from, for example, a silicon substrate. In the nozzle palate 33b, a nozzle group composed of a plurality of nozzles Nz is provided. The nozzle palate 33b is manufactured from a conductive plate-like member such as, for example, a thin metal plate. A diaphragm 334 is provided at a portion opposite to each pressure chamber 331 in the vibration plate 33c. The diaphragm 334 is deformed by the piezoelectric element PZT, changing the volume of the pressure chamber 331. Since the vibration plate 33c, an adhesive, and the like are present between the piezoelectric element PZT and the nozzle palate 33b, the piezoelectric element PZT and nozzle palate 33b are electrically insulated from each other.

The piezoelectric element unit 34 has a piezoelectric group 341 and a fixing plate 342. The piezoelectric group 341 is shaped like a comb. Each tooth of the comb is one piezoelectric element PZT. The end face of each piezoelectric element PZT is bonded to an island portion 335, which is part of the diaphragm 334 opposite to the piezoelectric group 341. The fixing plate 342 supports the piezoelectric group 341. The case 32 is attached to the fixing plate 342. The piezoelectric element PZT is an example of an electromechanical conversion element. When a driving signal is applied to the piezoelectric element PZT, it expands and contracts in the longitudinal direction, causing a change in pressure in the liquid in the pressure chamber 331. Due to a change in the volume of the pressure chamber 331, the ink in the pressure chamber 331 undergoes a change in pressure. This change in pressure can be used to discharge the ink from the nozzle Nz. A structure may be used by which a bubble is generated according to an applied driving signal to discharge an ink droplet, instead of using the piezoelectric element PZT as an electromechanical conversion element.

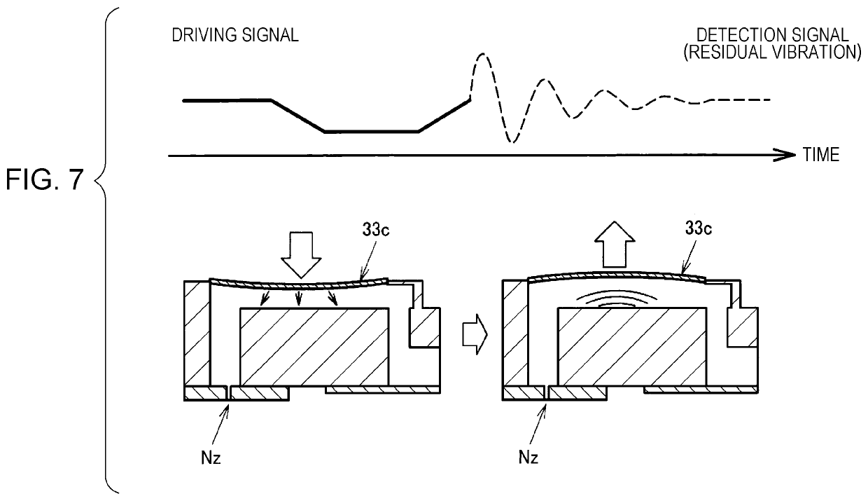

FIG. 7 illustrates the principle of the detection of a discharge failure by the second inspection unit 80. As illustrated in FIG. 7, when a driving signal is applied to the piezoelectric element PZT, it warps and the vibration plate 33c thereby vibrates. Even when the application of the driving signal to the piezoelectric element PZT is stopped, there is residual vibration in the vibration plate 33c. When the vibration plate 33c vibrates due to the residual vibration, the piezoelectric element PZT vibrates according to the residual vibration in the vibration plate 33c and outputs a signal. Therefore, by generating residual vibration in the vibration plate 33c and detecting a signal generated in the piezoelectric element PZT at that time, the property of each piezoelectric element PZT can be determined. Information based on the waveform of a signal generated in the piezoelectric element PZT due to residual vibration will be referred to as residual vibration waveform information or a waveform pattern.

A detection signal matching residual vibration in the piezoelectric element PZT is entered to the second inspection unit 80. The A/D converting section 82 in the second inspection unit 80 performs A/D conversion processing on the detection signal, and outputs waveform information, which is digital data. The waveform information is stored in the memory 103 and is used in learning processing and inference processing, which will be described later. The second inspection unit 80 may include a noise reduction section (not illustrated) and the like. Waveform information output from the second inspection unit 80 is not limited to a waveform itself, but may be information related to a cycle or amplitude. In this case, the second inspection unit 80 includes a waveform shaping section (not illustrated) and a measuring section (not illustrated) such as a pulse width detection section. When waveform information is successively acquired piezoelectric elements PZT corresponding to nozzles Nz, the property of each piezoelectric element PZT can be detected.

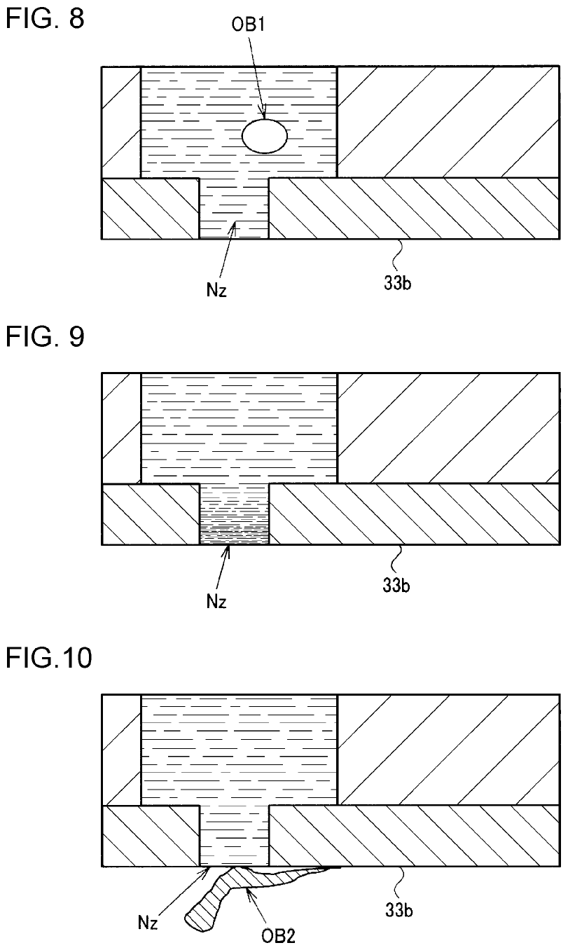

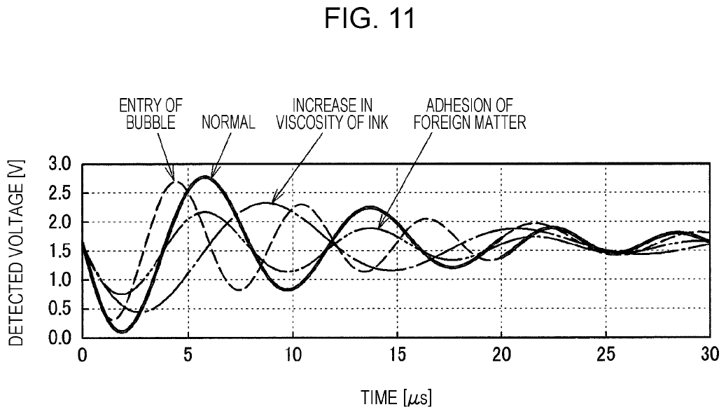

FIGS. 8 to 10 exemplify discharge failure factors. FIG. 11 illustrates waveform information about residual vibration matching the state of the nozzle Nz. FIG. 8 schematically illustrates a state in which a bubble has entered the interior of the print head 31. In FIG. 8, OB1 indicates a bubble. When a bubble enters the interior of the print head 31, the waveform of residual vibration has a shorter cycle than a waveform in the normal state, as illustrated in FIG. 11. FIG. 9 schematically illustrates a state in which the viscosity of ink in the print head 31 has increased. Increased viscosity represents a state in which the viscosity of ink is higher than in the normal state. When the viscosity of ink increases, the waveform of residual vibration has a longer cycle than a waveform in the normal state, as illustrated in FIG. 11. FIG. 10 schematically illustrates a state in which foreign matter has attached to the nozzle surface, which is the bottom surface of the print head 31. In FIG. 10, OB2 indicates foreign matter such as paper dust. When foreign matter attaches to the nozzle surface, the waveform of residual vibration has a lower amplitude than a waveform in the normal state, as illustrated in FIG. 11. As describe above, when a decision is made on waveform information about residual information, inspection for a discharge failure is possible.

1.4 Method in this Embodiment

In JP-A-2013-111768 as well, a method in which two detectors are combined together is disclosed. Since the method in JP-A-2013-111768 is intended to take appropriate action when a discharge failure occurs, however, it is difficult to use the method to suppress waste paper. Specifically, the print quality of printed matter produced from when a discharge failure occurs until the discharge failure is eliminated by recovery processing is low, so such printed matter becomes waste paper. When a business-use printer or the like produces printed matter with low quality, the printed matter cannot be used as commercial products. The generation of waste paper leads to a large loss.

In the decision described above in which waveform information about residual vibration is used, a change in waveform information is detected, the change being caused by an entry of a bubble, an increase in the viscosity of ink, the adhesion of foreign matter, or the like. Therefore, it seems that when waveform information about residual vibration is used, a discharge failure can be detected before it occurs. For example, it is thought that even when a bubble enters ink, a discharge failure does not occur immediately but, depending on the size and position of the bubble, it is determined whether a discharge failure occurs. Therefore, when, at the stage of a low level of the entry of a bubble, the entry of the bubble can be detected, a discharge failure can be prevented in advance by performing recovery processing.

In decision processing in which waveform information about residual vibration is used, however, the value of a cycle or amplitude is compared with a given threshold as disclosed in, for example, JP-A-2013-111768. To precisely detect the occurrence of a discharge failure according to waveform information about residual vibration, an appropriate threshold needs to be set. The user has been largely burdened with the need to set a threshold. When an attempt is made to predict a discharge failure that would occur in the future at a stage at which a clear failed dot has not occurred in a print result, that is, at which a discharge failure such as clogging has not occurred, a threshold is more difficult to set.

In this embodiment, therefore, processing to predict a discharge failure is performed by performing machine learning in which discharge failure factor information is used. In machine learning, it can be precisely inferred whether a discharge failure will occur in the future, making it possible to suppress waste paper. When highly precise inference is possible, it is also possible to suppress the need to excessively perform recovery processing such as cleaning or flushing. Therefore, ink consumption involved in recovery processing can be suppressed. Since it is also possible to suppress the need to stop printing during recovery processing, productivity can be improved.

In this embodiment, printed image information representing an image formed on a print medium is also used in learning. In a narrow sense, printed image information is a decision result for a discharge failure, the decision being based on the image formed on the print medium. The decision result is used as a correct answer label in machine learning. Therefore, training data used in learning processing can be automatically collected with ease, and learning processing can be efficiently executed. Leaning processing and inference processing in this embodiment will be described below in detail.

### 2. Learning Processing

### 2.1 Example of the Structure of a Learning Apparatus

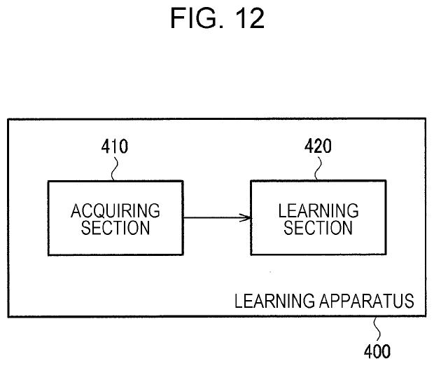

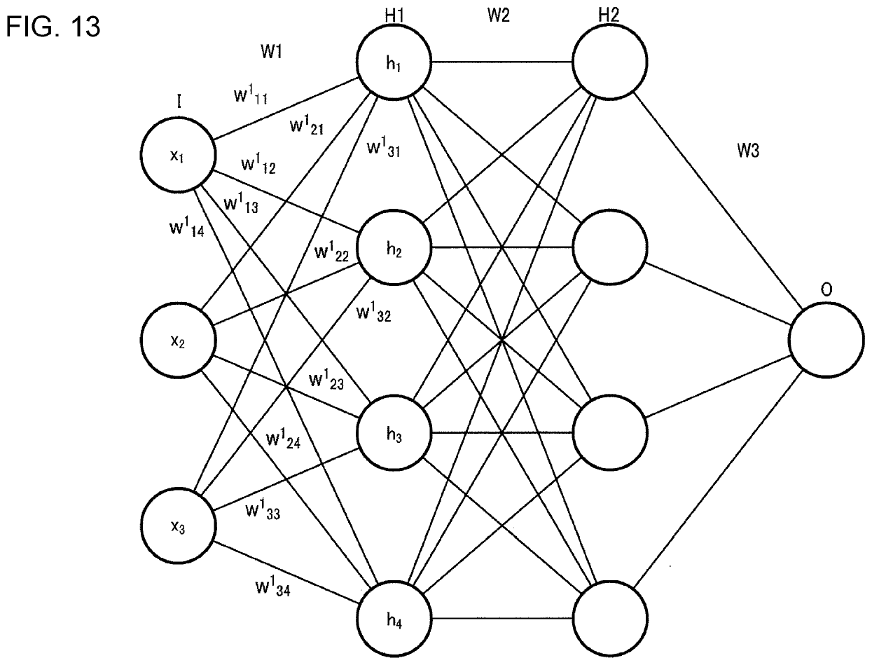

FIG. 12 illustrates an example of the structure of a learning apparatus 400 in this embodiment. The learning apparatus 400 includes an acquiring section 410 that acquires training data used in learning, as well as a learning section 420 that performs learning according to the training data.

The acquiring section 410 is, for example, a communication interface that acquires training data from another apparatus. Alternatively, the acquiring section 410 may acquire training data held in the learning apparatus 400. The learning apparatus 400 includes, for example, a storage (not illustrated), in which case the acquiring section 410 is an interface that reads training data from the storage. Learning in this embodiment is, for example, a supervised learning. Training data in supervised learning is a data set in which input data and correct answer labels are mutually associated.

The learning section 420 performs machine learning based on training data acquired by the acquiring section 410, and creates a machine-learned model. The learning section 420 in this embodiment is structured by hardware described below. The hardware can include at least one of a circuit that processes digital signals and a circuit that processes analog signals. For example, the hardware can be composed of one or plurality of circuit devices mounted on a circuit board or one or a plurality of circuit elements. The one or plurality of circuit devices are, for example, integrated circuits (ICs) or the like. The one or plurality of circuit elements are, for example, resistors, capacitors, and the like.

The learning section 420 may be implemented by a processor described below. The learning apparatus 400 in this embodiment includes a memory that stores information and a processor that operates according to the information stored in the memory. The information is, for example, programs and various types of data. The processor includes hardware. As the processor, a central processing unit (CPU), a graphics processing unit (GPU), a digital signal processor (DSP), or any of other types of processor can be used. The memory may be a semiconductor memory such as a static random access memory (SRAM) or a dynamic random access memory (DRAM), or may be a register. Alternatively, the memory may be a magnetic storage device such as a hard disk unit or an optical storage device such as an optical disk unit. The memory stores, for example, computer-readable instructions. When instructions stored in the memory are executed by the processor, the functions of sections in the learning apparatus 400 are implemented as processing. The instructions referred to here may be instructions in an instruction set constituting a program, or may be instructions that command operations for hardware circuits in the processor. The memory stores, for example, a program that stipulates a learning algorithm. The processor operates according to the algorithm and executes learning processing.

More specifically, the acquiring section 410 acquires discharge failure factor information about the print head 31 and printed image information about the detection result for an image formed on a print medium with ink discharged from the print head 31. A discharge failure in the print head 31 is specifically a discharge failure in the nozzle Nz included in the print head 31. The learning section 420 machine-learns a prediction condition for a discharge failure in the print head 31, according to a data set in which discharge failure factor information and printed image information are mutually associated. The predictions condition referred to here represents various conditions such as numeric values, ranges, and change trends in discharge failure factor information used to decide that the probability that a discharge failure will occur in the future is high. In other words, the learning section 420 creates a machine-learned model that predicts whether a discharge failure will occur in the future according to discharge failure factor information.

Discharge failure factor information is information related to a discharge failure factor. A discharge failure factor is an event that causes a discharge failure. A discharge failure factor is, for example, an entry of a bubble, an increase in the viscosity of ink, the adhesion of foreign matter, or the like described above with reference to FIGS. 8 to 10.

When, in the print head 31 in the printing apparatus 1, a voltage is applied to a piezoelectric element and ink is thereby discharged, discharge failure factor information includes waveform information about residual vibration caused by the application of a voltage to the piezoelectric element. Specifically, the piezoelectric element is the piezoelectric element PZT described above. Since waveform information about residual vibration is changed by an entry of a bubble or the like as described above, waveform information about residual vibration is information related to a discharge failure factor. Thus, it becomes possible to appropriately predict the occurrence of a discharge failure by making waveform information about residual vibration eligible for machine learning.

It is known that the degree at which the occurrence of a discharge failure factor such as an entry of a bubble is affected by parameters, such as temperature, humidity, atmospheric pressure and an altitude, in the environment in which the printing apparatus 1 is used. When an environmental parameter such as temperature changes, a change occurs in, for example, a place in the printing apparatus 1 where a bubble is likely to be generated, the ease with which a bubble is generated, and the ease with which the generated bubble moves. The properties of ink, including viscosity, also changes according to temperature or the like. A change in temperature or the like also causes a change in the ease with which foreign matter adheres to the nozzle surface. When, for example, the frequency of the occurrence of static electricity on the nozzle surface is increased by a change in an environmental parameter such as humidity or the surface of the print medium becomes likely to be fluffy, adherence of foreign matter is likely to occur. Thus, environmental parameters such as temperature can be said to be information related to discharge failure factors, so the environmental parameters are included in discharge failure factor information in this embodiment. By making environmental parameters eligible for machine learning, it becomes possible to appropriately predict the occurrence of a discharge failure.

Printed image information includes image data acquired by sensing an image formed on a print medium, as well as information obtained according to the image data. Information obtained according to image data includes, for example, a decision result for print quality, the decision being based on a discharge failure in the print head 31. More specifically, printed image information may be information that represents a decision result representing whether there is a vertical stripe or horizontal stripe in the print result.

Printed image information is, for example, information based on an image captured by the imaging section 71 disposed in the printing apparatus 1. Then, machine learning can be performed according to captured image information, which is an imaging result produced by the imaging section 71. The imaging section 71, which is specifically an area image sensor, can acquire image data in a wide area by one sensing. By using printed image information, it is possible to directly detect an abnormality in the print result.

The imaging section 71 may be disposed in the head unit 30 including print heads 31. More specifically, the imaging section 71 is disposed on the carriage 21, on which the print heads 31 are mounted, as illustrated in FIG. 4. Then, a distance becomes adequately short between an area toward which ink is discharged and an area in which imaging performed by the imaging section 71. For example, the imaging section 71 may use an area toward which ink is discharged as the imaging area. Since a time from when printing is completed until printed image information is acquired can be shortened, it becomes possible to quickly confirm a print result. Particularly, when the printing apparatus 1 is a printer in a serial head method, with the imaging section 71 mounted on the carriage 21, a print result can be imaged while the imaging section 71 is being moved. However, printed image information in this embodiment may be acquired by using a line image sensor as in, for example, JP-A-2013-111768.

According to the method in this embodiment, machine learning is performed by using a data set in which discharge failure factor information and printed image information are combined together. When a learning result is used, it becomes possible to precisely infer whether a discharge failure will occur, according to, for example, actually measured discharge failure factor information. Thus, when waveform information about residual vibration, for example, is used, manual threshold setting and the like become unnecessary, and a highly precise decision becomes possible. Since a future discharge failure can also be predicted, it becomes possible to appropriately execute recovery processing before ink is not actually discharged. That is, the generation of waste paper can be suppressed.

The learning apparatus 400 illustrated in FIG. 12 may be included in, for example, the printing apparatus 1 in FIG. 1. In this case, the learning section 420 corresponds to the controller 100 in the printing apparatus 1. More specifically, the learning section 420 may be the processor 102. The printing apparatus 1 accumulates waveform information, received from the second inspection unit 80, about residual vibration and sensing data received from the detector group 90 as operation information. The acquiring section 410 may be an interface that reads operation information accumulated in the memory 103. The printing apparatus 1 may transmit the accumulated operation information to an external device such as the computer CP or a server system. The acquiring section 410 may be the interface section 101 that receives training data necessary for learning from the external device.

The learning apparatus 400 may be included in a device other than the printing apparatus 1. For example, the learning apparatus 400 may be included in an external device that collects operation information about the printing apparatus 1 or in another apparatus that can communicate with the external device.

### 2.2 Neural Network

Machine learning in which a neural network is used will be described as a specific example of machine learning. FIG. 13 illustrates an example of the basic structure of a neural network. A neural network is a mathematical model that simulates brain functions on a computer. One circle in FIG. 13 is referred to as a node or neuron. In the example in FIG. 13, the neural network has an input layer, two intermediate layers, and an output layer. The input layer is denoted I, the two intermediate layers are denoted H1 and H2, and the output layer is denoted by O. In the example in FIG. 13, the number of neurons in the input layer is 3, the number of neurons in each intermediate layer is 4, and the number of neurons in the output layer is 1. However, various variations are possible for the number of intermediate layers and the number of neurons included in each layer. Each neuron included in the input layer is joined to the neurons in the intermediate layer H1, referred to below as the first intermediate layer. Each neuron included in the first intermediate layer is joined to the neurons in the intermediate layer H2, referred to below as the second intermediate layer. Each neuron included in the second intermediate layer is joined to the neurons in the output layer. The intermediate layer may also be referred to as the hidden layer.

Each neuron in the input layer outputs an input value. In the example in FIG. 13, the neural network accepts x1, x2, and x3 as an input, after which the neurons in the input layers in the neural network output x1, x2, and x3. Some kind of preprocessing may be performed on input values, and each neuron in the input layer may output a value after preprocessing.

In each neuron in the intermediate layers and subsequent layer, computation is performed that simulates a state in which information is transmitted in the brain as electric signals. In the brain, the ease with which information is transmitted changes depending on the strength of synaptic coupling. In the neural network, therefore, the coupling strength is represented by a weight W. W1 in FIG. 13 is a weight between the input layer and the first intermediate layer. W1 represents a set of weights, each of which is a weight between a given neuron included in the input layer and a given neuron included in the first intermediate layer. When a weight between a p-th neuron in the input layer and a q-th neuron in the first intermediate layer is represented as a weight w¹_{pq}, W1 in FIG. 13 is information including 12 weights w¹₁₁ to w¹₃₄. In a broader sense, the weight W1 is information composed of the same number of weights as the product of the number of neurons in the input layer and the number of neurons in the first intermediate layer.

Computation indicated by equation (1) below is performed in a first neuron in the first intermediate layer. In one neuron, a product is obtained for an output from each neuron in the layer placed immediately before the one neuron and coupled to the one neuron, and such products are summed, after which a bias is added. The bias in equation (1) below is b1.

$${h}_{1} = f ( {\sum }_{i} {w}_{i 1}^{1} \cdot {x}_{i} + {b}_{1} ) \qquad ( 1 )$$

In computation in one neuron, an activation function f, which is a non-linear function, is used as indicted by equation (1) above. A ReLU function indicated by equation (2) below, for example, is used as an activation function f. A ReLU function takes 0 when a variable is 0 or smaller, and takes the value of the variable itself when the variable is larger than 0. However, it is known that any of various other functions can be used as an activation function f. A sigmoid function may be used or an improved function of a ReLU function may be used. Equation (1) above is an example of a computation equation for h1. Computation can be similarly performed for other neurons in the first intermediate layer as well.

$$f ( x ) = max ( 0 , x ) = \{ \begin{matrix}0 ( x \leq 0 ) \\ x ( x \geq 0 )\end{matrix} \qquad ( 2 )$$

The above similarly applies to the subsequent layer as well. For example, a weight between the first intermediate layer and the second intermediate layer is assumed to be W2. Then, in computation in the neurons in the second intermediate layer, an activation function is applied by using outputs from the first intermediate layer and the weight W2 to perform multiply-and-accumulation and then adding a bias. In computation in the neurons in the output layer, weighted addition is performed for outputs from the layer immediately before the output layer and then a bias is added. In the example in FIG. 13, the layer immediately before the output layer is the second intermediate layer. In the neural network, a computation result in the output layer is an output from the neural network.

As seen from the above description, to obtain a desired output from inputs, a weight and bias need to be appropriately set. In the description below, a weight will also be referred to as a weighting coefficient. A bias may be included in a weighting coefficient. In learning, a data set in which a given input x and a correct output for the input are mutually associated is prepared. A correct output is a correct answer label. Learning processing in a neural network can be thought as processing to obtain the most probable weighting coefficient according to the data set. In learning processing in a neural network, various learning methods such as backpropagation are known. In this embodiment, these learning methods can be widely applied, so detailed description will be omitted. A learning algorithm employed when a neural network is used is, for example, an algorithm in which both processing to acquire a forward result by performing computation as in equation (1) above or the like and processing to update weighting coefficient information by using backpropagation are performed.

A neural network is not limited to the structure illustrated in FIG. 13. For example, a convolutional neural network (CNN), which is widely known in learning processing in this embodiment and inference processing described later, may be used. A CNN has a convolutional layer and a pooling layer. In the convolutional layer, convolutional computation is performed. The convolutional computation referred to here is specifically filer processing. In the pooling layer, processing to reduce the vertical and horizontal sizes of data is performed. In the CNN, when learning processing in which backpropagation or the like is used is performed, the property of a filter used in convolutional computation is learned. That is, the weighting coefficient in a neural network includes the filer property in the CNN. A network having another structure such as a recurrent neural network (RNN) may be used as a neural network.

So far, an example in which a machine-learned model is a model that uses a neural network has been described. However, machine learning in this embodiment is not limited to a method in which a neural network is used. For example, machine learning in widely known various other methods such as a support vector machine (SVM) or machining learning in methods developed from these methods can be applied as the method in this embodiment.

### 2.3 Examples of Training Data and Details of Learning Processing

### 2.3.1 Examples of Training Data and Learning Processing

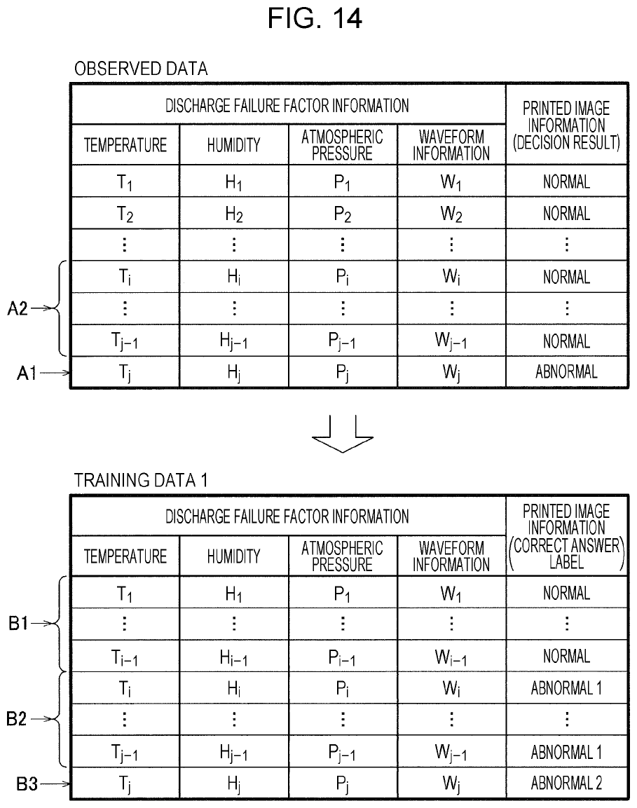

FIG. 14 indicates observed data acquired in the printing apparatus 1 and training data acquired according to the observed data. The observed data in FIG. 14 is acquired for a given one nozzle Nz. Similar observed data is also acquired for other nozzles Nz as well. In FIG. 14, the letter i is a natural number larger than 1 and the letter j is a natural number larger than i.

Observed data includes discharge failure factor information and printed image information. The discharge failure factor information includes temperature information, humidity information, atmospheric pressure information, and waveform information about residual vibration. The discharge failure factor information may include other information such as altitude information.

The imaging section 71 acquires captured image data by imaging a print result in a given area. The captured image data referred to here is image data used in one decision processing. Captured image data may be data acquired by one imaging section 71 in one imaging. Alternatively, captured image data may be combined image data in which a plurality of images captured by one imaging section 71 in time series are combined, or may be combined image data in which a plurality of images captured by a plurality of imaging sections 71 are combined. As described above, the image processor 72 compares captured image data with reference data to acquire, for each of a plurality of nozzles Nz, a decision result indicating whether the print result is normal or abnormal.

The second inspection unit 80 outputs waveform information about residual vibration for each nozzle Nz at least once in a period during which one piece of captured image data is acquired. Various modifications are possible for a specific acquisition timing. When the printing apparatus 1 is in a serial head method, for example, waveform information about residual vibration is observed once for one reciprocation of the carriage 21. The waveform information referred to here is, for example, a waveform itself. Specifically, the waveform information is a set of a plurality amplitude values acquired in time series. However, the waveform information may be information about the maximum amplitude value, a cycle, or the like.

The temperature sensor 91 outputs temperature information, which is a sensing result, at least once in a period during which one piece of captured image data is acquired. Alternatively, the temperature sensor 91 may output a plurality of pieces of temperature information in the above period. Then, a statistic value, such as the average of the plurality of pieces of temperature information, may be used as discharge failure factor information. This similarly applies to the humidity sensor 92, atmospheric pressure sensor 93, and other sensors as well. Information in various forms can be used as temperature information and atmospheric pressure information. As for the temperature sensor 91, humidity sensor 92, and atmospheric pressure sensor 93, sensors in various structures are known. In this embodiment, these sensors can be widely applied, so detailed description will be omitted.

As described above, when outputs from sections in the printing apparatus 1 are appropriately associated, observed data is acquired for each nozzle Nz in time-series as indicated in FIG. 14. In FIG. 14, Tₛ, s being a positive integer, represents temperature information acquired at a timing before Tₛ₊₁. This similarly applies to other information as well. Information in FIG. 14 is time-series information acquired in the order from top to bottom. Here, printed image information is information output when a print result is directly imaged. When printed image information is abnormal, therefore, this indicates that there is a vertical stripe or horizontal stripe in the print result, that is, print quality is low.

In this embodiment, therefore, printed image information may be used as a correct answer label. In a machine-learned model acquired through machine learning, machine learning is performed for discharge failure factor information according to a data set in which a decision result indicating a discharge failure according to the printed image information is associated as a correct answer label. Thus, a correct answer label can be automatically acquired. Since a large amount of training data can be efficiently acquired, precision in learning can be improved.

For each piece of observed data in FIG. 14, for example, it is thought that learning processing is executed by using discharge failure factor information as an input and also using a decision result, which is printed image information, as a correct answer label. However, this type of machine-learned model acquired through machine learning is a model that produces an output indicating whether there is a discharge failure in the nozzle Nz at a timing corresponding to the entered discharge failure factor information. When, for example, discharge failure factor information acquired at the current time is entered, the machine-learned model outputs a decision result indicating whether there is a discharge failure in the nozzle Nz at the current time. When such a method is used, an effect is obtained in that precision in decision based on waveform information or the like can be made higher than in methods in related art. Since a discharge failure can be inferred from discharge failure factor information, another effect is obtained in that even when to-be-printed image data does not include a detection-enabled pattern, the method is adaptable. However, after a discharge failure has actually occurred, the discharge failure is detected. This makes it hard to suppress waste paper.

In this embodiment, therefore, editing processing is performed on printed image information by analyzing the printed image information in time series. In other words, a decision result made for a discharge failure according to printed image information is not limited to a decision result at a single timing, but includes time-series analysis results. In the description below, it will be assumed that the learning section 420 performs the above editing processing. The editing processing may be performed by the printing apparatus 1 or may be performed by, for example, a server system that collects operation information.

Specifically, the learning section 420 detects a point at which printed image information, which is a decision result, changes from normal to abnormal, as indicated by A1 in FIG. 14. Discharge failure factor information in this embodiment is information related to a discharge failure factor. When a discharge failure occurs due to a discharge failure factor, it is thought that a completely normal state is not immediately shifted to an abnormal state, but a sign is generated before an abnormality occurs. When, for example, a bubble enters ink, the inability to discharge ink does not occur immediately after the entry of the bubble. Instead, the bubble first enters the ink from a flow path, after which the position of the bubble that has entered the ink, for example, is changed while printing is in progress. When a state is entered in which the bubble hinders ink from being discharged, a discharge failure occurs. Therefore, even when a print result itself was normal during a predetermined period before an abnormality had occurred, it is thought that there is a change of some kind in the discharge failure factor information due to the entry of the bubble. This similarly applies to other discharge failure factors such as an increase in the viscosity of ink and the attachment of foreign matter. In a predetermined period before an abnormality, therefore, the learning section 420 creates training data by rewriting a decision result in a range indicated by, for example, A2 in FIG. 14 to “abnormal”.

Training data B1 in FIG. 14 is an example of data after editing processing. Now, to distinguish between a state in which the print result is normal but it may change to an abnormal state from now on and a state in which there is an actual abnormality in the print result, the learning section 420 assigns a correct answer label called “abnormal 1” to the former case and also assigns a correct answer label called “abnormal 2” to the latter case. However, these cases may be classified together as “abnormal”. In the example in FIG. 14, data in the range B2 is assigned the correct answer label “abnormal 1” and data in the range B3 is assigned the correct answer label “abnormal 2”. In the range B1, even after a certain length of period has elapsed, a normal print result is maintained, so a correct answer label “normal” is assigned.

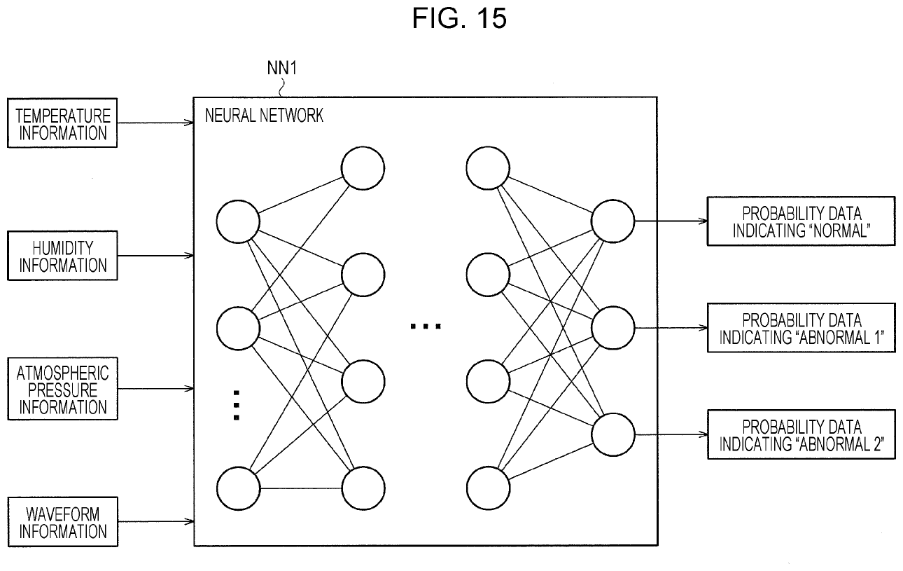

FIG. 15 illustrates an example of a model of a neural network in this embodiment. The neural network NN1 accepts discharge failure factor information as an input, and outputs information representing a decision result for a discharge failure as output data. Information representing a decision result for a discharge failure is specifically information that represents whether the result is “normal”, “abnormal 1” representing that a discharge failure may occur in the future, or “abnormal 2” representing that a discharge failure already has occurred. The output layer in the neural network NN1 may be a widely known softmax layer. In this case, the neural network NN1 produces three outputs, probability data representing “normal”, probability data representing “abnormal 1” and probability data representing “abnormal 2”.

Learning processing based on, for example, training data in FIG. 14 is performed according to a flow described below. First, the learning section 420 enters input data to the neural network NN1, after which the learning section 420 performs a forward computation by using a weight at that time to acquire output data. When training data in FIG. 14 is used, input data is discharge failure factor information. Output data obtained by the forward computation is composed of three pieces of probability data, the total sum of which is 1, as described above.

The learning section 420 performs a computation of an error function according to the obtained output data and a correct answer label. When training data in FIG. 14 is used, for example, the correct answer label is information in which the value of the corresponding probability data is 1 and the values of the other two pieces of probability data are 0. When “abnormal 1”, for example, is assigned, a specific correct answer label is information in which probability data indicating “abnormal 1” has a value of 1 and probability data indicating “normal” and probability data indicating “abnormal 2” have a value of 0.

The learning section 420 calculates, as an error function, the degree of a difference between three pieces of probability data obtained in the forward computation and three pieces of probability data corresponding to correct answer labels, and updates weighting coefficient information in such a way that error is reduced. Error functions in various other forms are known. In this embodiment, these error functions can be widely applied. Although backpropagation, for example, is used to update weighting coefficient information, another method may be used.

So far, learning processing based on one piece of training data has been outlined. The learning section 420 repeats similar processing on other training data, and learns appropriate weighting coefficient information. For example, the learning section 420 uses part of acquired data as training data, and also uses the rest as test data. Test data can also be referred to as evaluation data or verification data. The learning section 420 applies test data to a machine-learned model created from training data, and continues learning until a correct answer rate reaches at least a predetermined threshold.

In learning processing, it is known that the more the number of pieces of training data is increased, the more precision is improved. FIG. 14 exemplifies observed data acquired before a decision result indicating abnormality appears once in a given one nozzle Nz. However, it is desirable to prepare much more training data for the nozzle Nz by acquiring many pieces of observed data.

The learning section 420 may create a machine-learned model for each of a plurality of nozzles Nz. As described above with reference to FIG. 6, however, all print heads 31 have the same structure and all nozzles Nz have the same structure. Therefore, it is thought that when an event that causes a discharge failure occurs, the trend of discharge failure factor information is common to the plurality of nozzles Nz. In view of this, the learning section 420 may create one machine-learned model according to training data for a plurality of nozzles Nz. This makes it possible to efficiently correct training data.

In editing processing to create training data 1 from observed data, however, printed image information needs to be analyzed in time series. Therefore, it is desirable to perform processing for each nozzle Nz at the stage at which training data 1 is to be created from observed data. After training data 1 has been acquired, there is no need to consider that which data is information about which nozzle Nz. All training data 1 can be used in learning processing for the neural network NN1.

Even when the nozzles Nz have a common structure, when the nozzles Nz discharge different inks, their trends of discharge failure factor information may differ. When the targeted printing apparatus 1 uses a plurality of different types of inks, the learning section 420 may create a machine-learned model for each type of ink. Types of inks may be types of colors such as cyan and magenta, types of color materials such as dyes and pigments, or both. Alternatively, the learning section 420 may add information about ink types to an input in learning processing to create a machine-learned model adaptable to a plurality of types of inks.

### 2.3.2 Another Example of Training Data

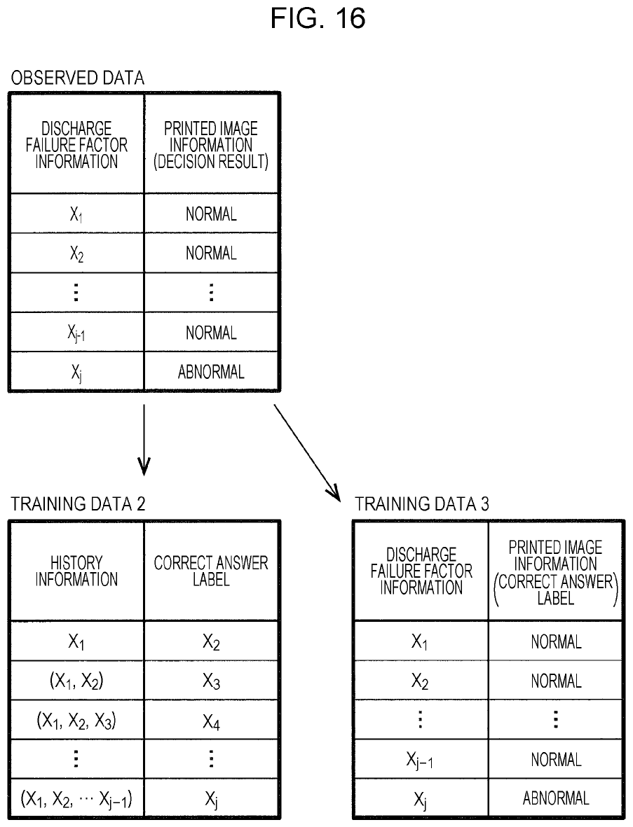

Training data and the structure of a neural network used in learning processing in this embodiment are not limited to the training data in FIG. 14 and the structure in FIG. 15. FIG. 16 illustrates another example of observed data acquired in the printing apparatus 1 and training data acquired according to the observed data. To simplify FIG. 16, discharge failure factor information is represented as Xᵢ. Specifically, Xᵢ is a set of temperature information, humidity information, atmospheric pressure information, waveform information about residual vibration, and the like at the relevant timing. For example, Xᵢ is equal to (Tᵢ, Hᵢ, Pᵢ, W₁). Observed data is as in FIG. 14.

The learning section 420 creates training data 2 and training data 3 from observed data. Training data 2 is a data set in which discharge failure factor information corresponding to a timing later than a given timing is associated with history information in discharge failure factor information corresponding to the given timing as a correct answer label. History information is time-series discharge failure factor information. In the example in FIG. 16, history information has a variable length and is restricted to one piece of discharge failure factor information. However, history information may be fixed-length data. Training data 3, which is observed data itself, is a data set in which printed image information is associated with discharge failure factor information as a correct answer label.

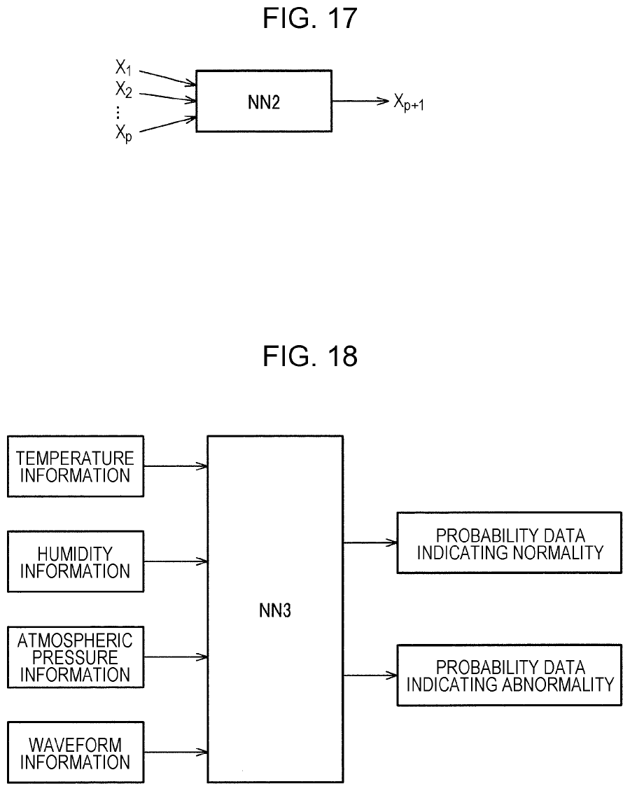

FIG. 17 illustrates an example of a model of a neural network NN2 in this embodiment. Although not illustrated in FIG. 17 and FIG. 18, which will be referenced later, the neural network NN2 and a neural network NN3 each have an input layer, one or a plurality of intermediate layers, and an output layer as in, for example, the neural network NN1.

The learning section 420 performs learning processing on the neural network NN2 according to training data 2. The learning section 420 enters history information in training data 2 to the neural network NN2, after which the learning section 420 performs a forward computation by using a weight at that time to acquire output data. A result in the forward computation is a predicted value for discharge failure factor information in the future. When, for example, training data 2 in FIG. 16 is used, p in FIG. 17 is an integer of at least 1 and at most j−1. The learning section 420 performs a computation of an error function according to the obtained output data and a correct answer label. When input data is, for example, (Xᵢ, X₂, . . . , Xⱼ₋₁), the correct answer label is X₁. Therefore, the learning section 420 calculates, as an error function, the degree of a difference between X and the result of the forward computation, and updates weighting coefficient information in such a way that error is reduced. As for the neural network NN2 as well, the above processing is repeated by using a large amount of training data to determine weighting coefficient information.

FIG. 18 illustrates an example of a model of the neural network NN3 in this embodiment. The learning section 420 performs learning processing on the neural network NN3 according to training data 3. The learning section 420 enters discharge failure factor information in training data 3 to the neural network NN3, after which the learning section 420 performs a forward computation by using a weight at that time to acquire output data. A result in the forward computation is a decision result for a discharge failure at that time. More specifically, output data is composed of two pieces of probability data, which are probability data indicating normality and probability data indicating abnormality. The learning section 420 performs a computation of an error function according to the obtained output data and a correct answer label. When input data is, for example, Xᵢ, the correct answer label is information in which probability data indicating normality has a value of 1 and probability data indicating abnormality has a value of 0. The learning section 420 calculates, as an error function, the degree of a difference between the result of the forward computation and the correct answer label, and updates weighting coefficient information in such a way that error is reduced. As for the neural network NN3 as well, the above processing is repeated by using a large amount of training data to determine weighting coefficient information.

When the neural network NN3 is used, it becomes possible to precisely infer whether there is a discharge failure according to discharge failure factor information. When the neural network NN2 is used, it becomes possible to predict discharge failure factor information in the future according to history information in discharge failure factor information. That is, by combining the above two neural networks, it becomes possible to predict discharge failure factor information in the future and make a decision about a discharge failure according to the discharge failure factor information. Thus, it becomes possible to predict whether a discharge failure will occur in the future.

As illustrated in FIGS. 14 to 18, the method in this embodiment only needs to be capable of predicting a future discharge failure according to discharge failure factor information and printed image information. Various variations are possible for the forms of a specific model and the structure of training data.

### 3. Inference Processing

### 3.1 Example of the Structure of an Information Processing Apparatus

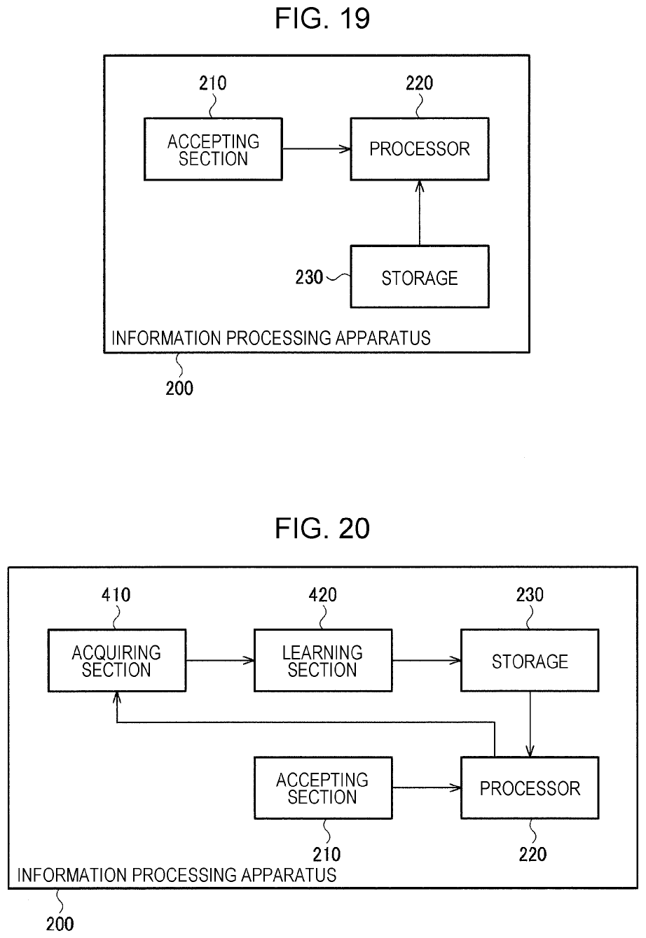

FIG. 19 illustrates an example of the structure of an inference apparatus in this embodiment. The inference apparatus is an information processing apparatus 200. The information processing apparatus 200 includes an accepting section 210, a processor 220, and a storage 230.

The storage 230 stores a machine-learned model in which a prediction condition has been machine-learned for a discharge failure in the print head 31 according to a data set in which discharge failure factor information and printed image information are mutually associated. The accepting section 210 accepts usage state information about temperature, humidity, the presence or absence of a print job, or the like as an input. The processor 220 outputs information representing a decision result related to a discharge failure, according to the machine-learned model and the discharge failure factor information accepted as an input.

As described above, there are various possible factors of discharge failures. In this embodiment, discharge failure factor information is information related to a discharge failure factor. By using actually measured discharge failure factor information, it becomes possible to precisely predict a discharge failure in the future. Thus, it becomes possible to suppress waste paper generated due to a discharge failure.

A machine-learned model is used as a program module, which is part of artificial-intelligence software. The processor 220 outputs data representing a prediction result for a discharge failure, the prediction result being based on the discharge failure factor information used as an input, in response to a command from the machine-learned model stored in the storage 230.

The processor 220 in the information processing apparatus 200 is composed of hardware that includes at least one of a circuit that processes digital signals and a circuit that processes analog signals, as with the learning section 420 in the learning apparatus 400. The processor 220 may be implemented by a processor describe below. The information processing apparatus 200 in this embodiment includes a memory that stores information and a processor that operates according to the information stored in the memory. As the processor, a CPU, a GPU, a DSP, or any of other types of processors can be used. The memory may be a semiconductor memory, a register, a magnetic storage device, or an optical storage device. The memory referred to here is, for example, the storage 230. That is, the storage 230 is an information storage medium such as a semiconductor memory, and a program such as a machine-learned model is stored in the information storage medium.

Computation performed in the processor 220 according to a machine-learned model, that is, computation to produce output data according to input data, may be executed by software or may be executed by hardware. In other words, multiply and accumulation in equation (1) above or the like may be executed by software. Alternatively, the above computation may be executed by a circuit device such as a field-programmable gate array (FPGA) or may be executed by a combination of software and hardware. Thus, the processor 220 can operate in various aspects in response to a command from the machine-learned model stored in the storage 230. For example, the machine-learned model includes an inference algorithm and parameters used in the inference algorithm. The inference algorithm performs, for example, multiply and accumulation in equation (1) above according to input data. The parameters, which are acquired through learning processing, include, for example, weighting coefficient information. In this case, the inference algorithm and parameters may be both stored in the storage 230. Then, the processor 220 may read the inference algorithm and parameters and may perform inference algorithm by software. Alternatively, the inference algorithm may be implemented by an FPGA or the like, and the storage 230 may store the parameters.

The information processing apparatus 200 in FIG. 19 is included in the printing apparatus 1 illustrated in, for example, FIG. 1. That is, the method in this method can be applied to the printing apparatus 1 including the information processing apparatus 200. In this case, the processor 220 corresponds to the controller 100 in the printing apparatus 1 and, in a narrow sense, to the processor 102. The storage 230 corresponds to the memory 103 in the printing apparatus 1. The accepting section 210 corresponds to an interface that reads discharge failure information accumulated in the memory 103. The printing apparatus 1 may transmit accumulated operation information to an external device such as the computer CP or server system. The accepting section 210 may be the interface section 101 that receives, from the external device, discharge failure factor information required for inference. However, the information processing apparatus 200 may be included in a device other than the printing apparatus 1. For example, the information processing apparatus 200 is included in an external device such as a server system that collects operation information including discharge failure factor information from a plurality of printing apparatuses 1. The external device performs inference processing related to a discharge failure for each printing apparatus 1 according to the collected operation information, and performs processing to transmit inferred information to the printing apparatus 1.

In the description above, the learning apparatus 400 and information processing apparatus 200 have been separated. However, this is not a limitation on the method in this embodiment. For example, as illustrated in FIG. 20, the information processing apparatus 200 may include the acquiring section 410 that acquires discharge failure factor information and printed image information, as well as the learning section 420 that machine-learns a prediction condition for a discharge failure according to a data set in which discharge failure factor information and printed image information are mutually associated. In other words, in addition to the structure in FIG. 19, the information processing apparatus 200 includes a structure corresponding to the learning apparatus 400 in FIG. 12. Thus, it becomes possible to efficiently execute both learning processing and inference processing in a single apparatus.

Processing performed by the information processing apparatus 200 in this embodiment may be implemented as an information processing method. In the information processing method, a machine-learned model is acquired and discharge failure factor information is accepted from the printing apparatus 1 having print heads 31, after which a discharge failure in the print head 31 is predicted according to the accepted discharge failure factor information and machine-learned model. In the machine-learned model referred to here, a predication condition has been machine-learned for a discharge failure in the print head 31 according to a data set in which an association is made between discharge failure factor information related to a discharge failure in the print head 31 that discharges ink and printed image information representing an image formed on a print medium by ink discharged from the print head 31, as described above.

### 3.2 Flow in Inference Processing

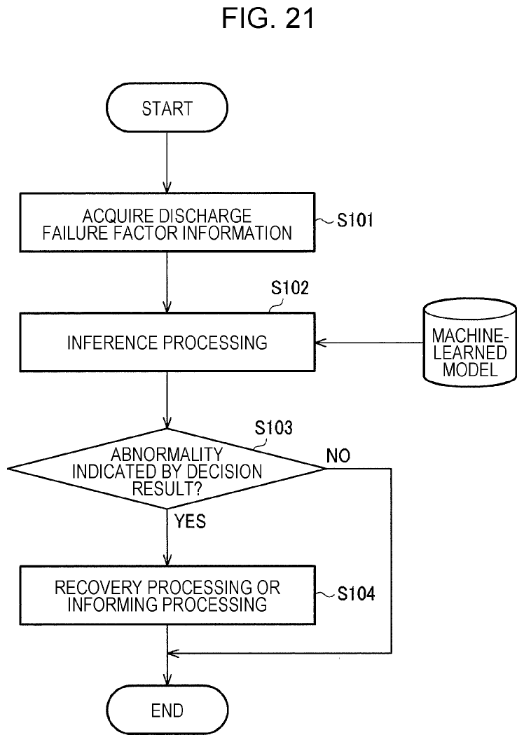

FIG. 21 is a flowchart illustrating processing in the information processing apparatus 200. When this processing starts, the accepting section 210 acquires discharge failure factor information first (S101). Then, the processor 220 performs decision processing in relation to a discharge failure according to the acquired discharge failure factor information and the machine-learned model stored in the storage 230 (S102). When the neural network NN1 illustrated in FIG. 15 is used, in processing in S102, three pieces of probability data representing “normal”, “abnormal 1” and “abnormal 2” are obtained, after which the maximum value is identified from the three pieces of probability data.

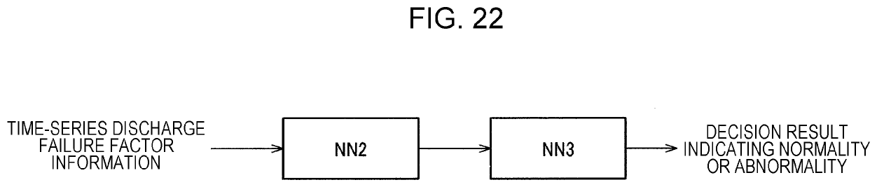

In S102, the processor 220 may use two neural networks illustrated in FIGS. 17 and 18. FIG. 22 schematically illustrates processing when the two neural networks are used. The processor 220 enters time-series discharge failure factor information including the discharge failure factor information acquired most recently to the neural network NN2. The processor 220 then enters output data created in the neural network NN2 to the neural network NN3. The output data in the neural network NN2 is a predicted value for discharge failure factor information in the future. Output data in the neural network NN3 is information representing a prediction result for discharge failure factor information in the future. The prediction result is composed of two pieces of probability data, each of which represents normality or abnormality.

In the example described above with reference to FIGS. 16 and 17, the neural network NN2 is used to predict discharge failure factor information corresponding to one timing later. To suppress the occurrence of waste paper, however, it is desirable that a discharge failure can be predicted with a certain degree of margin in time. For example, the processor 220 may predict discharge failure factor information corresponding to two timings or more later by using a predicted value for discharge failure factor information acquired by using the neural network NN2 as an input to the neural network NN3 and further performing computation with the neural network NN3. By entering a predicted result to the neural network NN3, the processor 220 can predict a discharge failure corresponding to two timings or more later. Alternatively, the learning section 420 may perform processing to create training data 2 and learning processing so that the neural network NN2 outputs a predicted value for discharge failure factor information corresponding to two timings or more later.

After processing in S102, the processor 220 makes a decision as to whether the decision result indicates abnormality (S103). When the decision result indicates abnormality (Yes in S103), the processor 220 performs recovery processing for the discharge failure (S104). In recovery processing, control is commanded to eliminate the discharge failure by, for example, ink suction by the ink suction unit 50, wiping by the wiping unit 55, or flushing by the flushing unit 60. Alternatively, in S104, the processor 220 may perform informing processing to inform the user of the discharge failure. For example, the processor 220 performs processing to display a screen on which the user is notified of the occurrence of the discharge failure or a screen on which the user is promoted to execute recovery processing on the display section (not illustrated) of the printing apparatus 1 or the display section of a computer CP. However, informing processing is not limited to the displaying of a screen, but may be processing to cause a light emitting section such as a light emitting diode (LED) to emit light or processing to output a warning sound from a speaker. Alternatively, the processor 220 may perform not only informing processing to inform the user of a discharge failure but also recovery processing.

When the neural network NN1 is used, the processor 220 may select processing to be performed in S104 depending on whether the decision result is “abnormal 1” or “abnormal 2”. When the decision result is “abnormal 2”, it is desirable to execute recovery processing immediately because a discharge failure has already occurred. When the decision result is “abnormal 1”, there is a high probability that a discharge failure may occur but no discharge failure has occurred at the present time. Therefore, the processor 220 automatically executes recovery processing when the decision result is “abnormal 2” and executes informing processing to prompt the user to execute recovery processing when the decision result is “abnormal 1”, for example. However, the processor 220 may perform the same processing for both “abnormal 1” and “abnormal 2”. In this case, learning processing may be performed by taking “abnormal 1” and “abnormal 2” as the same “abnormal” without these abnormalities being distinguished from each other at the learning stage as well.

As described above, the processor 220 performs recovery processing to recover from a discharge failure or informing processing on a discharge failure according to the prediction result for the discharge failure. This makes it possible to execute an appropriate action or issue a prompt for an appropriate action before a discharge failure occurs. Therefore, the occurrence itself of a discharge failure can be suppressed and waste paper can thereby be suppressed.

In inference processing in which a failure in the print head 31 is predicted, printed image information is not requisite as illustrated in FIG. 21. However, printed image information can be used in, for example, a decision about the hue of printed matter or a decision about the deviation of a printing position. Therefore, it is desirable for the printing apparatus 1 to periodically acquire printed image information separately from processing illustrated in FIG. 21. When additional learning to update a machine-learned model is performed as will be described later, printed image information needs to be acquired to create training data.

### 4. Additional Learning

In this embodiment, the learning stage and inference stage may be clearly distinguished from each other. For example, learning processing has been performed in advance by, for example, the manufacturer of the printing apparatus 1, and a machine-learned model is stored in the memory 103 in the printing apparatus 1 at the time of shipping of the printing apparatus 1. At the stage at which the printing apparatus 1 is used, the stored machine-learned model is fixedly used.

However, the above is not a limitation on the method in this embodiment. Learning processing in this embodiment may include initial learning to create an initial machine-learned model and additional learning to update the machine-learned model. An initial machine-learned model is, for example, a general-purpose machine-learned model stored in the printing apparatus 1 in advance before shipping as described above. Additional learning is, for example, learning processing to update the machine-learned model according to the usage situation of the individual user or to a change in the performance of the print head 31 or the main body of the printing apparatus 1 due to the time-dependent change of the printing apparatus 1. Even after shipping, the machine-learned model is updated, enabling printing quality to be maintained.

Additional learning may be executed in the learning apparatus 400. The learning apparatus 400 may be an apparatus different from the information processing apparatus 200. However, the information processing apparatus 200 performs processing to acquire discharge failure factor information for the sake of inference processing. The discharge failure factor information can be used as part of training data in additional learning. In view of this, additional learning may be performed in the information processing apparatus 200. Specifically, the information processing apparatus 200 includes the acquiring section 410 and learning section 420 as illustrated in FIG. 20. The acquiring section 410 acquires discharge failure factor information. For example, the acquiring section 410 acquires information that the accepting section 210 has received in S101 in FIG. 21. The learning section 420 updates a machine-learned model according to a data set in which printed image information is associated with discharge failure factor information.

The printed image information referred to here is specifically a decision result for a discharge failure, the decision result being acquired by comparing captured image data with reference data. Thus, since training data can be easily accumulated in the printing apparatus 1 while it is operating, the machine-learned model can be appropriately updated. As described above, however, when the to-be-printed image data does not include a detection-enabled pattern, however, a decision cannot be made about a discharge failure according to the captured image data. To update the machine-learned model, therefore, the printed image information needs to be information acquired by taking a picture of an image including a detection-enabled pattern with which a discharge failure can be detected.

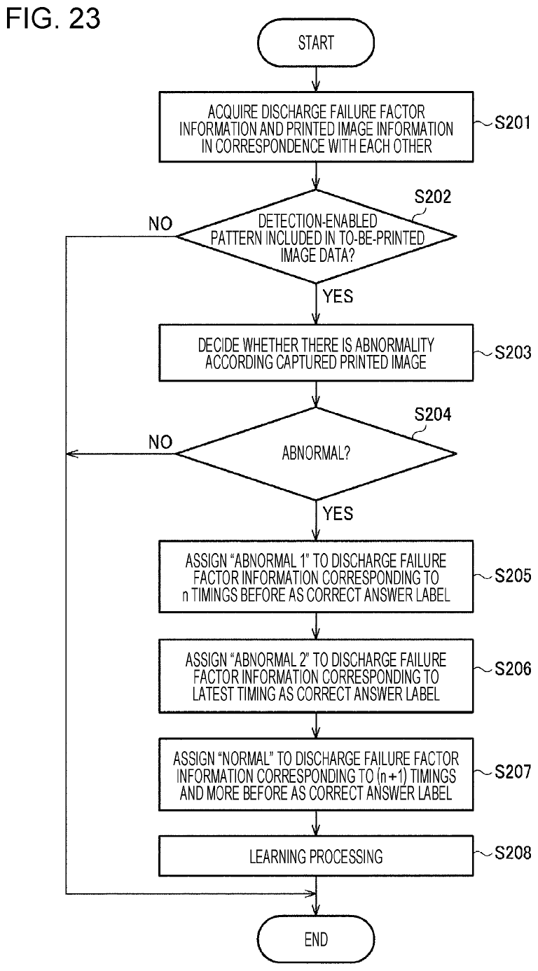

FIG. 23 is a flowchart for additional learning. When this processing is started, the acquiring section 410 acquires discharge failure factor information and printed image information in correspondence with each other (S201). Printed image information in S201 is captured image data. The learning section 420 acquires to-be-printed image data from the controller 100 and decides whether the acquired to-be-printed image data includes a detection-enabled pattern (S202). When a detection-enabled pattern is included (Yes in S202), the learning section 420 decides whether there is a discharge failure according to the to-be-printed image data and the captured image data acquired in S201 (S203). When there is a discharge failure, the learning section 420 mutually associates the decision result and discharge failure factor information. When processing performed as described above, data equivalent to observed data in FIG. 14 is acquired.

When the decision result is “abnormal” (Yes in S204), the latest observed data corresponds to A1 in FIG. 14. Therefore, the learning section 420 assigns the correct answer label “abnormal 1” to the discharge failure factor information corresponding to n timings before as indicated at B2 in FIG. 14 (S205), where n is a given integer. In the example in FIG. 14, n is j−1. The learning section 420 also assigns the correct answer label “abnormal 2” to the discharge failure factor information corresponding to the latest timing as indicated at B3 in FIG. 14 (S206). The learning section 420 also assigns the correct answer label “normal” to the discharge failure factor information corresponding to (n+1) timings and more before as indicated at B1 in FIG. 14 (S207). Thus, data similar to training data 1 in FIG. 14 is acquired. Then, the learning section 420 executes learning processing based on training data as additional learning (S208).

When the to-be-printed image data does not include a detection-enabled pattern (No in S202), a normality/abnormality decision cannot be made for the latest timing, in which case the learning section 420 terminates the processing without assigning a correct answer label or performing learning processing. When the decision result indicates “normal” (No in S204), the learning section 420 also terminates the processing without assigning a correct answer label or performing learning processing.

When abnormality is decided according to the printed image information in the example in FIG. 23, additional learning is executed. In consideration of the capacities of the memories in the printing apparatus 1 and information processing apparatus 200, data to be held may be restricted. The learning section 420 does not need to handle all data assigned a correct answer label in learning. For example, in consideration that a discharge failure is predicted in advance, the learning section 420 may perform additional learning for training data assigned the correct answer label “abnormal 1”.

When normality is decided according to the printed image information or the to-be-printed image data does not include a detection-enabled pattern, learning processing may be performed. Even when the decision result based on the printed image information is normal, a correct answer label may be rewritten to “abnormal 1” as has been indicated at A2 and B2 in FIG. 14. However, observed data that may be rewritten is restricted to observed data corresponding to n timings or less before. Therefore, correct answer labels corresponding to (n+1) timings or more before may be determined to be “normal”. When, for example, the decision result is normal in all periods from timing 1 to timing (n+1), the correct answer label corresponding to timing 1 is “normal” and can never be rewritten to “abnormal 1”. In this case, therefore, the learning section 420 may assign correct answer label “normal” to discharge failure factor information corresponding to timing 1 and may perform additional learning.

In the example in FIG. 23, additional learning in which the neural network NN1 in FIG. 15 has been described. However, additional learning may be performed by using the neural network NN2 in FIG. 17 and the neural network NN3 in FIG. 18.

For example, the printing apparatus 1 continues to acquire discharge failure factor information as operation information. The learning section 420 assumes the latest discharge failure factor information as a correct answer label, and performs additional learning based on the neural network NN2 by using training data in which the input is time-series discharge failure factor information before the latest discharge failure factor information. In learning based on the neural network NN2, it does not matter whether the to-be-printed image data includes a detection-enabled pattern.

When the to-be-printed image data includes a detection-enabled pattern, the learning section 420 performs additional learning based on the neural network NN3 by using training data in which printed image information, which is a decision result, is assigned to the latest discharge failure factor information as a correct answer label. In learning based on the neural network NN3, time-series analysis of printed image information is not requisite as described above with reference to FIG. 16, and additional learning based on data corresponding to one given timing is possible.

As described above, an information processing apparatus in this embodiment includes a storage that stores a machine-learned model, an accepting section, and a processor. In the machine-learned model, according to a data set in which an association is made between discharge failure factor information related to the factor of a discharge failure in a print head that discharges ink and printed image information that represents an image formed on a print medium by ink discharged from the print head, a prediction condition has been machine-learned for the discharge failure in the print head. The accepting section accepts the discharge failure factor information from a printing apparatus having the print head. The processor predicts the discharge failure in the print head according to the accepted discharge failure factor information and the machine-learned model.

According to the method in this embodiment, a discharge failure is predicted according to a machine-learned model, which is a result obtained by machine-learning a relationship between discharge failure factor information and printed image information. By using machine learning, it becomes possible to highly precisely infer whether a discharge failure will occur in the future. Since recovery processing or the like can be performed before a discharge failure occurs, inappropriate printing can be suppressed.

The printed image information may be information based on an image captured by an imaging section provided in the print apparatus.

Accordingly, it becomes possible to use information based on a captured image in machine learning.

The imaging section may be disposed on a carriage on which the print head is mounted.

Accordingly, it becomes possible to image a print result quickly and efficiently.

The print head may discharge ink when a voltage is applied to a piezoelectric element. The discharge failure factor information includes waveform information about residual vibration generated when a voltage is applied to the piezoelectric element.

Accordingly, it becomes possible to predict a discharge failure according to waveform information about residual vibration generated in a piezoelectric element.

The discharge failure factor information may include at least one of temperature information, humidity information, atmospheric pressure information, and altitude information.

Accordingly, it becomes possible to appropriately predict a discharge failure according to an environmental parameter related to the discharge failure.

The information processing apparatus may include an acquiring section that acquires the data set in which the discharge failure factor information and the printed image information are mutually associated, as well as a learning section that machine-learns the prediction condition for the discharge failure according to the acquired data set.

Accordingly, it becomes possible to execute learning processing in the information processing apparatus.

When the printed image information is information acquired by taking a picture of an image including a pattern with which the discharge failure can be detected, the learning section may update the machine-learned model according to the data set in which an association is made between the printed image information and the discharge failure factor information acquired at a timing corresponding to the printing of the printed image information.

Accordingly, it becomes possible to execute additional learning processing according to a specific state of the printing apparatus.

In the machine-learned model, machine-learning has been performed according to the data set in which a decision result for the discharge failure, the decision result being based on the printed image information, is associated with the discharge failure factor information as a correct answer label.

Accordingly, since a correct answer label can be automatically acquired, it becomes possible to efficiently perform learning processing.

The processing unit may perform recovery processing for the discharge failure or informing processing related to the discharge failure according to a prediction result for the discharge failure.

Accordingly, it becomes possible to take an appropriate action according to a prediction result for a discharge failure.

A printing apparatus in this embodiment includes the information processing apparatus and print head that have been described above.

A learning apparatus in this embodiment has an acquiring section and a learning section. The acquiring section acquires a data set in which an association is made between discharge failure factor information related to a discharge failure in a print head that discharges ink and printed image information that represents an image formed on a print medium by the ink discharged from the print head. The learning section machine-learns a prediction condition for the discharge failure in the print head according to the acquired data set.

According to the method in this embodiment, a condition under which a discharge failure will occur in the future is machine-learned according to discharge failure factor information and printed image information. By using machine learning, it becomes possible to highly precisely infer whether a discharge failure will occur in the future.

An information processing method in this embodiment is a method in which a machine-learned model is acquired, discharge failure factor information is accepted from a printing apparatus having a print head, and a discharge failure in the print head is predicted according to the accepted discharge failure factor information and machine-learned model. In the machine-learned model, according to a data set in which an association is made between the discharge failure factor information related to the factor of a discharge failure in the print head that discharges ink and printed image information that represents an image formed on a print medium by the ink discharged from the print head, a prediction condition has been machine-learned for the discharge failure in the print head.

So far, this embodiment has been described in detail. However, it will be understood by those skilled in the art that many variations are possible without substantively departing from the novel items and effects in this embodiment. Therefore, these variations are all included in the range of the present disclosure. For example, when a term is descried at least once in the specification or the drawings together with a different term that has a broader sense than the term or is synonymous with the term, the term can be replaced with the different term at any portion in the specification or the drawings. All combinations of this embodiment and its modifications are also included in the range of the present disclosure. Various modifications are possible for the structures, operations, and the like of the learning apparatus, the information processing apparatus, and the system including these apparatuses, without being limited to those described in this embodiment.

What is claimed is:

1. An information processing apparatus comprising:
a storage that stores a machine-learned model in which, according to a data set in which an association is made between discharge failure factor information related to a factor of a discharge failure in a print head that discharges an ink and printed image information that represents an image formed on a print medium by the ink discharged from the print head,
a prediction condition was machine-learned for the discharge failure in the print head;
an accepting section that accepts the discharge failure factor information from a printing apparatus having the print head; and
a processor that predicts the discharge failure in the print head according to the machine-learned model and the discharge failure factor information that was accepted.

2. The information processing apparatus according to claim 1, wherein the printed image information is information based on an image captured by an imaging section provided in the print apparatus.

3. The information processing apparatus according to claim 2, wherein the imaging section is disposed on a carriage on which the print head is mounted.

4. The information processing apparatus according to claim 1, wherein:
the print head discharges the ink when a voltage is applied to a piezoelectric element; and
the discharge failure factor information includes waveform information about residual vibration generated when the voltage is applied to the piezoelectric element.

5. The information processing apparatus according to claim 4, wherein the discharge failure factor information includes at least one of temperature information, humidity information, atmospheric pressure information, and altitude information.

6. The information processing apparatus according to claim 1, further comprising:
an acquiring section that acquires the data set in which the discharge failure factor information and the printed image information are mutually associated; and
a learning section that machine-learns the prediction condition for the discharge failure according to the data set that was acquired.

7. The information processing apparatus according to claim 6, wherein when the printed image information is information acquired by taking a picture of an image including a pattern with which the discharge failure is detectable, the learning section updates the machine-learned model according to the data set in which an association is made between the printed image information and the discharge failure factor information acquired at a timing corresponding to printing of the printed image information.

8. The information processing apparatus according to claim 1, wherein in the machine-learned model, machine-learning was performed according to the data set in which a decision result for the discharge failure, the decision result being based on the printed image information, is associated with the discharge failure factor information as a correct answer label.

9. The information processing apparatus according to claim 1, wherein the processing unit performs recovery processing for the discharge failure or informing processing related to the discharge failure according to a prediction result for the discharge failure.

10. A printing apparatus comprising:
the information processing apparatus according to claim 1; and
the print head.

11. A learning apparatus comprising:
an acquiring section that acquires a data set in which an association is made between discharge failure factor information related to a discharge failure in a print head that discharges an ink and printed image information that represents an image formed on a print medium by the ink discharged from the print head; and
a learning section that machine-learns a prediction condition for the discharge failure in the print head according to the data set that was acquired.

12. An information processing method comprising:
acquiring a machine-learned model in which, according to a data set in which an association is made between discharge failure factor information related to a factor of a discharge failure in a print head that discharges an ink and printed image information that represents an image formed on a print medium by the ink discharged from the print head, a prediction condition was machine-learned for the discharge failure in the print head;
accepting the discharge failure factor information from a printing apparatus having the print head; and
predicting the discharge failure in the print head according to the machine-learned model and the discharge failure factor information that was accepted.
